(19) United States
(12) Patent Application Publication
(10) Pub. No.: US 2006/0209187 A1
(43) Pub. Date: Sep. 21, 2006

(54) Mobile video surveillance system

(76) Inventor: John Otis Farneman, Powell, OH (US)

Correspondence Address: LAW OFFICE OF TIMOTHY M. BARLOW, P.O. BOX 523272, SPRINGFIELD, VA, 22152, US

(21) Appl. No.: 11/232,498

(22) Filed: Sep. 22, 2005

Related U.S. Application Data
(60) Provisional application No. 60/662,770, filed on Mar. 17, 2005.

(51) Int. Cl. H04N 7/18; H04N 9/47

(52) U.S. Cl. 348/143

(57) ABSTRACT

A mobile video surveillance system includes a waterproof housing with an optically transparent window for a digital camera. The housing includes an internal power supply attached to the camera and an internal radio for wirelessly transmitting a picture signal. The camera may produce still images or movies. The radio may be a high-speed, secure, Ethernet radio. A receiver sends the picture signals to a computer network for viewing with a standard web browser, PDA, or dedicated monitoring system. The camera is remotely-controllable, through the radio, for pan, tilt, zoom, frame rate, and image quality. The window may be a hemispherical dome, incorporated into and protruding from the housing. The housing is shock-resistant, waterproof and impervious to changes in barometric pressure and humidity. A solar power generator may be attached to the power supply, and the solar panel may be incorporated into at least one exterior surface of the housing.

### PRIORITY DATA

This application claims benefit of U.S. Provisional Patent Application serial No. 60/662770 filed on Mar. 17, 2005.

### BACKGROUND OF THE INVENTION

1. Field of the Invention

The present invention relates to security video systems, and more specifically to a portable, weatherproof, wireless, remotely-controllable mobile video surveillance system.

2. Description of the Related Art

Video security systems are well known. Such devices include closed-circuit television systems (CCTV), simple motion-picture video cameras with recording media within the camera or remotely located, and cameras that record a series of still images in response to a stimulus. These systems all have several drawbacks. The foremost of these is that the camera systems need to be permanently mounted or fixed into a vehicle, building or other structure. These systems require both power and transmission cables to feed power to the camera and to transmit images and information to a user. Simply setting up such a camera with its power supply and communications cables can take many hours to several days, depending upon the location of the camera and its surroundings. Currently, there is no ability to quickly deploy a camera that is entirely self-contained.

Therefore, there has been and continues to be a need for a surveillance camera system that is completely self-contained, so that it requires no external cabling. Such a camera system requires no permanent mounting location or dedicated supports, enabling it to operate properly from nearly any location, environment and position.

### SUMMARY OF THE DISCLOSURE

The device is a mobile video surveillance system that permits a user to set up in any location very quickly. Usually the time required is only a few minutes or the time it takes you to place the packs. For example, a SWAT team could place one of these in front of a building in a minute or less and monitor the building from a concealed position immediately.

Such a device is operable from a considerable distance, depending on terrain and the type of wireless communication system used. Such a device saves labor costs and is not an obvious, intrusive observational presence. A number of these mobile video surveillance systems can be placed around a building so that one man can do the surveillance and monitoring of six men or more. The information from the mobile video surveillance system is all viewable from a standard web browser or dedicated monitor.

As another example, the mobile video surveillance system can be set up on building tops in a matter of minutes to unobtrusively observe events in a city environment.

The industrial high-speed secure ethernet radio is wired into the camera. The radio is also wired into the power source thus enabling mobile video monitoring, surveillance or reconnaissance.

Accordingly, it is a principal object of the invention to disclose a mobile video surveillance system that operates independently, without any need for external power or communications cables.

It is another object of the invention to teach a mobile video surveillance system that allows a digital video image to be viewed through the Internet using standard web browsers and without special or proprietary software.

It is a further object of the invention to disclose a mobile video surveillance system that allows a secure surveillance video to be viewed through any video-capable monitor, computer or PDA.

It is an object of the invention to provide improved elements and arrangements thereof for the purposes described which is inexpensive, dependable and fully effective in accomplishing its intended purposes.

It is an object of the present invention to accomplish the foregoing objectives in a simple and cost effective manner.

These and other objects of the present invention will become readily apparent upon further review of the following specification and drawings.

### BRIEF DESCRIPTION OF THE DRAWINGS

FIG. 1 is an environmental view of the mobile video surveillance system in a communications network, in accordance with the present invention;

FIG. 2 is a perspective view of the mobile video surveillance system, in accordance with the present invention;

FIG. 3 is a perspective view of the mobile video surveillance system, in accordance with the present invention; and

FIG. 4 is a perspective view of the mobile video surveillance system, in accordance with the present invention.

### DETAILED DESCRIPTION OF THE PREFERRED EMBODIMENT

The following detailed description is of the best presently contemplated modes of carrying out the invention. This description is not to be taken in a limiting sense, but is made merely for the purpose of illustrating general principles of embodiments of the invention.

The present invention provides a mobile video surveillance system that operates independently, without any need for external power or communications cables.

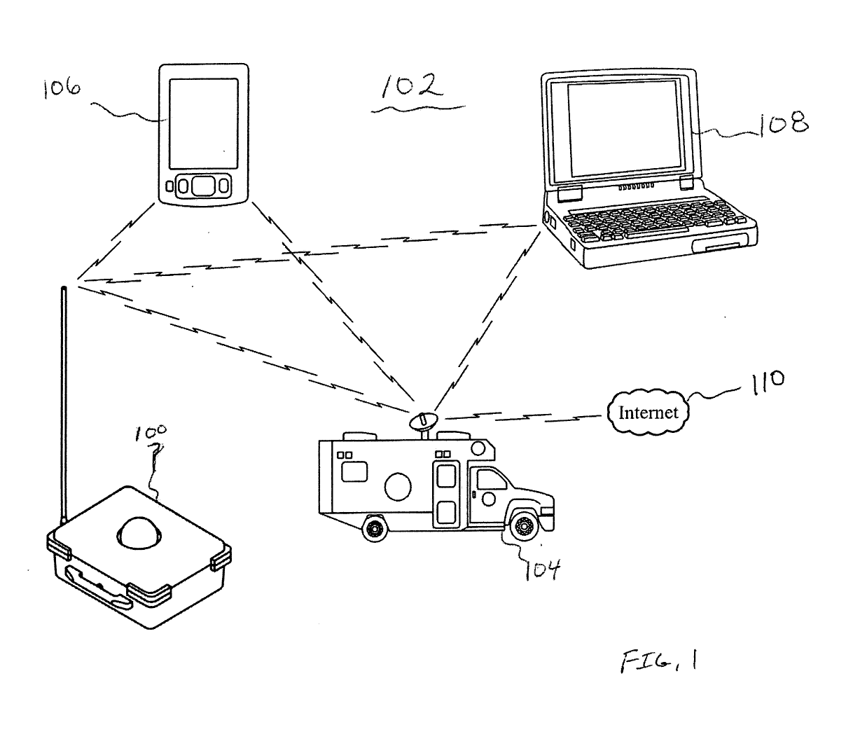

FIG. 1 shows an environmental view of a mobile video surveillance system 100 in a communications network 102. The communications system 102 shown includes a mobile communications station 104, a PDA 106 and a personal computer 108. Each member of the communications network 102 may receive information from the mobile video surveillance system 100 directly, or from the mobile communications station 104.

Virtually any device that can receive and display the images can be a part of the communications network 102. The mobile communications station 104 may be a vehicle, an office, or any place the equipment can be properly deployed and set up to receive and process signals to and from the mobile video surveillance system 100. The communications station 104 may provide images and information to a server for distribution to the Internet. From the Internet, authorized users can access the images from virtually anywhere in the world.

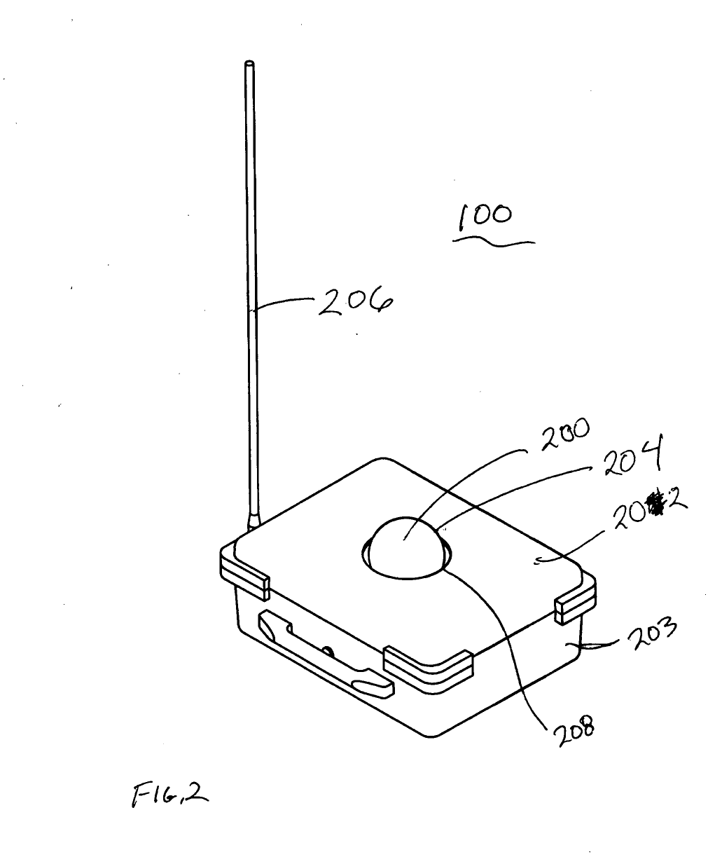

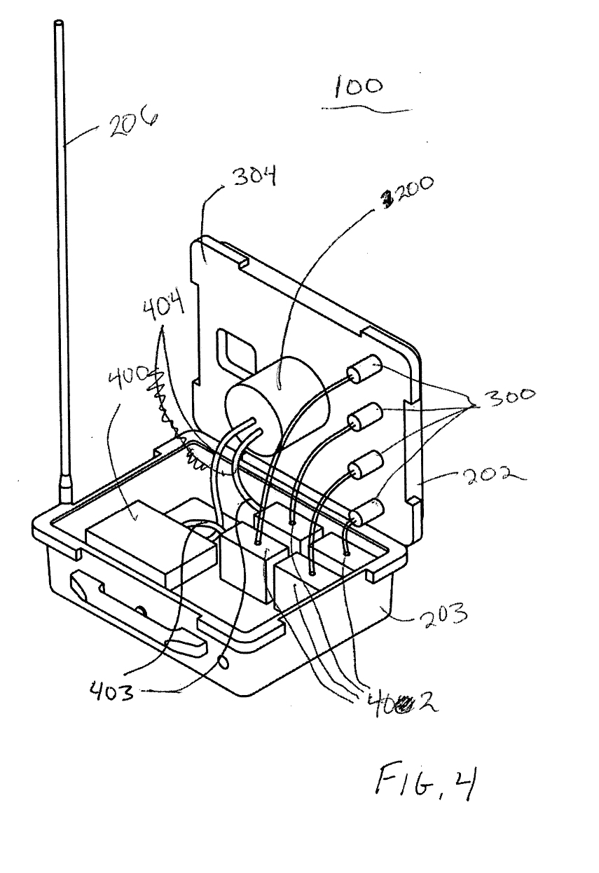

FIG. 2 shows a perspective view of the mobile video surveillance system 100 as it would be deployed. The camera 200 is housed within a waterproof and shock-resistant housing having a lid 202 and a base 203. For example, a Pelican® brand case, could be used to house the entire device. The camera 200 protrudes through an aperture 208 in the housing 202 and is protected by a transparent dome 204. A gasket or seal may be provided at the interface between the dome 204 and the lid 202 to guard against moisture and dirt. An antenna 206 is shown attached to the side of the housing base 203. The antenna cable is routed through a watertight grommet on the side of the housing base 203 where it attaches to an internal radio 400, see FIG. 4. In another embodiment, the antenna 206 is internal to the housing 202, 203, providing a less conspicuous package.

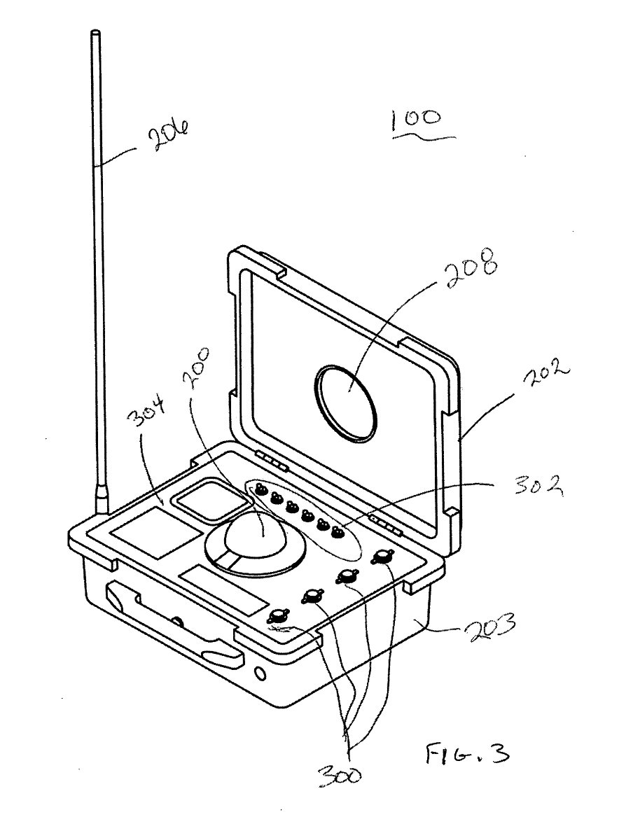

FIG. 3 is a perspective view of the mobile video surveillance system with the lid 202 open to reveal a control panel 304. A plurality of charging points 300 provide a convenient means for recharging the internal batteries 402, see FIG. 4. A plurality of switches 302 enable the user to apply power to the camera 200 and radio 400 individually, and to select or isolate each battery 402, as desired.

FIG. 4 is a perspective view of the mobile video surveillance system with the control panel 304 opened. The base of the camera 200 extends down into the internal space of the housing base 203, between the radio 400 and the batteries 402. A pair of power cables 403 attach the camera 200 and the radio 400 to the batteries 402. A cable 404 links the camera 200 to the radio 400. The plurality of charging points 300 are attached to each battery to provide recharging capability.

The user has numerous options for the mobile video surveillance system. For example, the camera 200 may be one of several currently on the market, such as the AXIS 232d Network Dome Camera. Such a camera has day and night capability, variable frame rate and resolution, 360-degree pan and 90-degree tilt, both optical and digital zoom capability, and supports encrypted communications. The AXIS camera is a 24 volt device, so a 24 volt power source is housed within the case to power it. A plurality of 12 volt batteries may be used to create 24 volts. Of course, other cameras with similar or greater capabilities may be used depending upon the application, such as the Sony RPU-C2512 or RPU-C3522. The Sony product operates on only 6-8 volts, but at a lower resolution. Thus, the user has several options from which to create the optimal device for his application. If properly equipped, the device can also transmit audio information to the user.

Small versions can mount on the tactical helmets of SWAT team members and military personnel.

In one embodiment, the radio is an industrial high-speed secure Ethernet radio. For example, with a LOCUS OS2400-HSE Industrial High Speed Ethernet Radio, the range is up to about five miles in rough terrain or urban environments, and up to 25 miles for line-of sight operation. Communications to and from the radio may be encrypted so that unauthorized persons cannot access the transmitted images or affect camera operation. The radio is secure and fast.

### Operation

The mobile video surveillance system is quite simple to use and powerful in operation. The batteries 402 are charged and the switches 302 are set to supply power to the camera 200 and the radio 400. The system 100 is then taken to a place near the area under surveillance. The camera may be carefully placed in a particular position, or it may be unceremoniously dropped into position. It does not matter what orientation the system 100 is in as long as the dome 204 is at least partially facing the surveillance area. The camera 200 is adjustable for pan, tilt and zoom, so orientation is not an important issue.

The radio 400 starts broadcasting as it is turned on, though the may not process any images until it is directed to by the user. A receiver (not shown) receives the signals from the radio 400. The receiver may be in a mobile communications station 104 or other location with radio range.

The communications station 104 processes the radio signals for distribution to a broadcast antenna or an Internet server. Alternatively, radio signals can be sent and received at a viewing monitor directly, without the communications station. The viewing monitor may be a PDA, personal computer or other device capable of receiving and displaying the image data from the camera 200.

If the camera is asleep or in a transport mode, the user first activates or “wakes up” the camera 200 to start collecting images. The user sends control signals to the camera 200 via the radio 400 to direct the movement and operation of the camera 200. All functional parameters of the camera 200 may be controlled wirelessly. The user who is controlling the camera 200 may be located nearby or virtually anywhere in the world when the signals are sent through the Internet 110.

The system 100 is quite flexible in use and is appropriate in a number of sensitive situations. For example, the system 100 can be camouflaged to match the surroundings in urban or rural areas. Various color schemes and external modifications can be implemented to disguise the true nature of the system 100. Screens or other semi-transparent materials may be placed over or around the dome to reduce glare or reflections and further reduce the likelihood of the system 100 being discovered. The antenna 206 may be incorporated into the base 203 to eliminate that telltale sign of a radio.

Additionally, the system 100 may be dropped via aircraft into remote locations. A parachute can be secured to the system 100 to facilitate a relatively gentle landing, with the dome 204 facing up. Of course, when the system 100 is in such a remote location, it is not possible to recharge the batteries in a conventional manner. In such instances it is desirable to incorporate a solar panel array into the lid 202. If multiple battery packs are used, one set of batteries can be charged while another set of batteries is used. All of these features can be controlled by the user, wirelessly.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A mobile video surveillance system, comprising:
a waterproof housing, comprising an optically transparent window;
a power supply inside the housing;
a digital camera inside the housing and attached to the power supply, where the camera receives light and images through the window; and
a radio linked to the camera and the power supply, where the radio wirelessly transmits a picture signal.

2. The mobile video surveillance system of claim 1, where the digital camera produces a plurality of digital still images.

3. The mobile video surveillance system of claim 1, where the digital camera produces motion videos.

4. The mobile video surveillance system of claim 1, further comprising a solar power generator attached to the power supply.

5. The mobile video surveillance system of claim 4, where the solar power generator is incorporated into at least one exterior surface of the housing.

6. The mobile video surveillance system of claim 1, where the radio is a high-speed, secure, Ethernet radio.

7. The mobile video surveillance system of claim 1, where the picture signal is received at a computer server that is accessible through a network.

8. The mobile video surveillance system of claim 7, where the picture signal is viewable via a standard web browser, PDA, or dedicated monitoring system.

9. The mobile video surveillance system of claim 1, where the camera is remotely controllable.

10. The mobile video surveillance system of claim 9, where the radio receives control signals from a remote user.

11. The mobile video surveillance system of claim 9, where the camera is remotely controllable for pan, tilt and zoom.

12. The mobile video surveillance system of claim 9, where the camera is remotely controllable for frame rate.

13. The mobile video surveillance system of claim 9, where the camera is remotely controllable for image quality.

14. The mobile video surveillance system of claim 1, where the window is a generally hemispherical dome, incorporated into and protruding from the housing.

15. The mobile video surveillance system of claim 1, where the housing is shock-resistant.

16. The mobile video surveillance system of claim 1, where the housing is waterproof.

17. The mobile video surveillance system of claim 1, where the housing is impervious to changes in barometric pressure and humidity.

18. A mobile video surveillance system, comprising:
a waterproof housing, comprising an optically transparent window;
a power supply inside the housing;
a remotely-controllable digital camera inside the housing and attached to the power supply, where the camera receives light and images through the window; and
a radio linked to the camera and the power supply, where the radio wirelessly transmits a picture signal and receives control signals for the camera.

19. The mobile video surveillance system of claim 18, where the window is a generally hemispherical dome, incorporated into and protruding from the housing.

20. The mobile video surveillance system of claim 18, where the radio is a high-speed, secure, Ethernet radio.

21. The mobile video surveillance system of claim 18, where the digital camera produces a plurality of digital still images.

22. The mobile video surveillance system of claim 18, where the digital camera produces motion videos.

23. The mobile video surveillance system of claim 18, where the picture signal is received at a computer server that is accessible through a network.

24. The mobile video surveillance system of claim 23, where the picture signal is viewable via a standard web browser, PDA, or dedicated monitoring system.

25. The mobile video surveillance system of claim 18, where the camera is remotely controllable for pan, tilt and zoom.

26. The mobile video surveillance system of claim 18, where the camera is remotely controllable for frame rate.

27. The mobile video surveillance system of claim 18, where the camera is remotely controllable for image quality.

28. The mobile video surveillance system of claim 18, where the housing a comprises a plurality of substantially flat sides where that housing made be placed in a plurality of orientations.

29. The mobile video surveillance system of claim 29, where the camera is operable in any housing orientation.
